(19) United States
(12) Patent Application Publication
(10) Pub. No.: US 2005/0073570 A1
(43) Pub. Date: Apr. 7, 2005

(54) Method and system for placarding

(76) Inventor: Kurt Alden, Aby (SE)

Correspondence Address: YOUNG & THOMPSON, 745 SOUTH 23RD STREET, 2ND FLOOR, ARLINGTON, VA, 22202, US

(21) Appl. No.: 10/680,237

(22) Filed: Oct. 8, 2003

Related U.S. Application Data
(60) Provisional application No. 60/417,161, filed on Oct. 10, 2002.

(51) Int. Cl. B41J 2/01

(52) U.S. Cl. 347/104

(57) ABSTRACT

Method of placarding comprising: feeding a sheet of corrugated cardboard through a printing unit printing on at least one surface of the sheet by a digital print-on-demand technique, the said sheet constituting an entire placarding surface and the matter printed by the printing unit constituting a complete advertising image. In a subsequent process step inline with the printing step at least one score or groove is made in the sheet in the feeding direction thereof and the sheet is folded about the score or groove to make an easily transportable unit of the sheet. The folded sheet is then transported to a placarding site having a holder for the sheet, where the sheet is unfolded and applied in the holder.

### CROSS REFERENCE TO RELATED APPLICATION

This application claims the benefit of U.S. Provisional Application No. 60/417,161 filed on Oct. 10, 2002.

### TECHNICAL FIELD OF THE INVENTION

The present invention refers to a method for placarding and a system adapted to the method.

### BACKGROUND OF THE INVENTION

The most common way of placarding is to put up thin sheets of printed paper on a surface intended for placarding. Standard methods of putting up large placards generally involve pasting a plurality of smaller sheets of paper, which are made to carry a part of an advertising message each, onto the placarding surface, so as to put together an entire advertising image. This is a time-consuming method that requires great skill of those pasting up the placards. Applying large advertising placards in this way also often results in inconvenient working positions, which may cause industrial images. It further means that the persons carrying out the placarding have to do this from a ladder or the like. This relatively time-consuming work also means that those pasting up the placards alongside a traffic route or a railway track are exposed to a further element of risk during this time.

With renewed placarding on the same placarding surface, the placard layers accumulate on top of each other, which means that the placarding surface gradually comes to carry a considerable weight and therefore, in order not to overload the surface, the placarding surface has to regularly be cleaned by tearing off the layers of placards. The accumulation of placard layers can also result in uneven and hence aesthetically unappealing surfaces, which can also make it more difficult to match up designs. Placarding with this method is difficult or even impossible in very cold or damp weather conditions.

EP-B1-0 976 121 discloses a method and system for placarding in which two or more sheets of corrugated cardboard are each carrying a printed section with advertising matter which in combination makes an advertising image. The sheets are folded and transported to a placarding site where they are placed in a holder and combined by specially designed fastening means to make up the complete advertising image.

Printing of the placarding sheets is made by block-printing or screen printing. It is not possible with such printing technique to quickly change printing pattern in order to print different patterns in a rapid succession in an inline process.

### SUMMARY OF THE INVENTION

One main object of the present invention is to provide a method and a system for placarding providing a rationalised procedure all the way from printing the advertising message onto a placard, handling of the placard sheet to the placarding site and putting up the placard. The method and system should be adapted to make it possible to quickly change printing pattern in order to print different patterns in a rapid succession in an inline process.

In accordance with the invention the method for placarding comprises the following steps:
a) feeding a sheet of corrugated cardboard through a printing unit comprising at least one printhead printing on at least one surface of said sheet by means of digital print-on-demand technique, said sheet constituting an entire placarding surface and the matter printed by the printing unit constituting a complete advertising image,
b) in a subsequent process step inline with the printing step making at least one score or groove in the sheet of corrugated cardboard in the feeding direction thereof,
c) folding the sheet about said at least one score or groove to make an easily transportable unit of said sheet,
d) transporting the folded sheet to a placarding site having a holder for the sheet,
e) unfolding the sheet and applying it in the holder.

In a preferred embodiment the printing technique used for printing said sheet of corrugated cardboard is selected from: inkjet printing, laser jet printing and toner jet printing.

The at least one score or groove is preferably made in the longitudinal direction of the fluting of the corrugated cardboard.

The invention also refers to a system for placarding, which comprises:
a) means for feeding a sheet of corrugated cardboard through a printing unit adapted to print on at least one surface of said sheet by means of digital print-on-demand technique, said sheet constituting an entire placarding surface and the matter printed by the printing unit constituting a complete advertising image;
b) means for making at least one score or groove in the sheet of corrugated cardboard in the feeding direction thereof, said means for printing and for making the score or groove being arranged in-line;
c) means for folding the sheet about said at least one score or groove to make an easily transportable unit of said sheet,
d) a holder placed at a placarding site said holder being adapted to receive the sheet in an unfolded position to expose the placarding image.

In a preferred embodiment the sheet of corrugated cardboard comprises a laminate having an inner layer of corrugated cardboard, at least one outer layer of bleached calendered liner and a hydrophobic or liquid impervious intermediate layer located between said outer layer of calendered liner and said inner layer of corrugated cardboard.

In one embodiment the calendered liner is a Kraft liner having a basis weight between 30 and 50 g/m².

Said intermediate layer in one embodiment of the invention is a coating or extrusion of a thermoplastic polymeric material. Preferably said coating has a basis weight between 10 and 30 g/m².

### BRIEF DESCRIPTION OF THE DRAWINGS

The invention will below be described more in detail with reference to an embodiment shown in the accompanying drawings.

FIG. 1a-f are schematic views illustrating the method from printing the placard to applying it in a holder for advertising.

FIG. 2 is a transverse sectional view through the corrugated cardboard used as placard sheet.

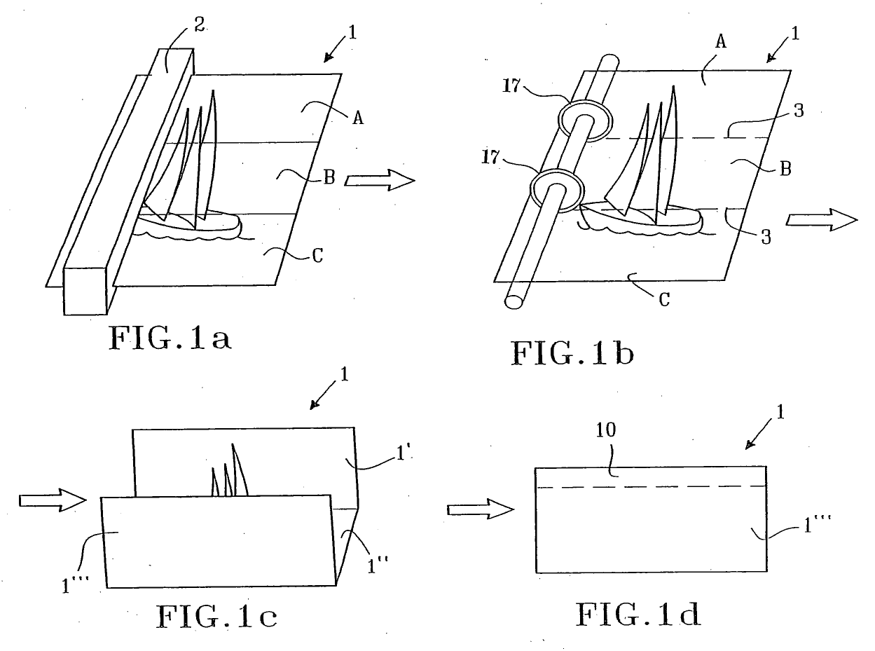

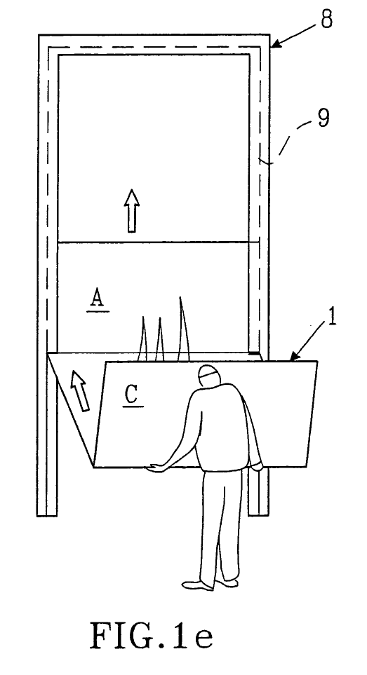

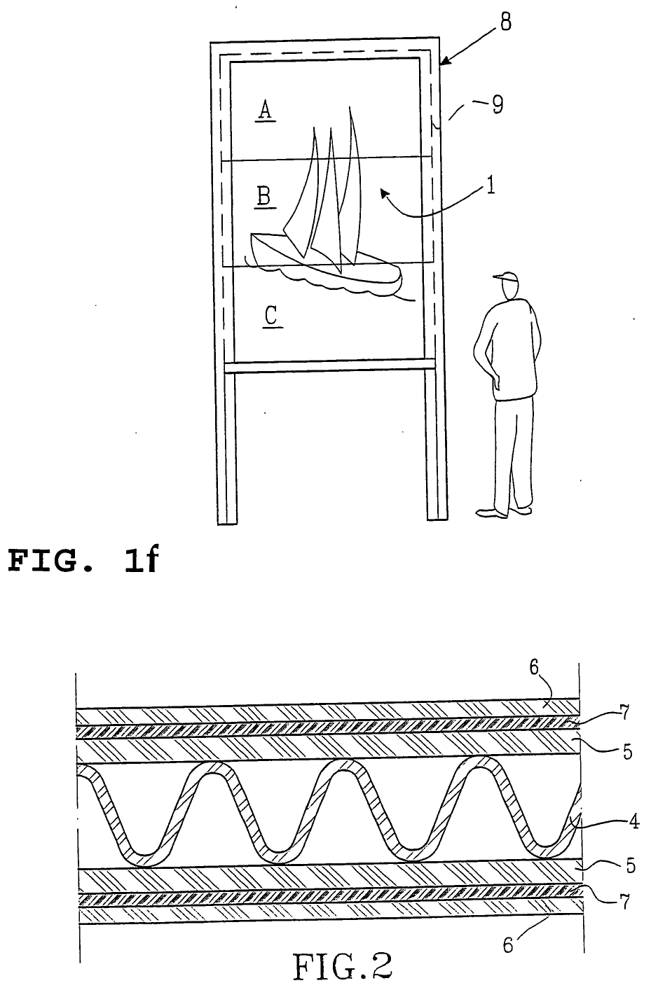

### DETAILED DESCRIPTION OF THE INVENTION

A sheet 1 of laminated corrugated cardboard is fed through a printing unit 2, preferably an inkjet printer, printing an advertising image on said sheet 1. The printing unit 2 is a digital print-on-demand unit having a printhead, which prints without exerting any mechanical pressure or direct physical contact between said sheet 1 and the printhead. In an inkjet printer the printhead structure is generally movable across the entire width of the sheet 1 to perform line by line scan printing in consecutive transversal lines. During each print sequence, one or several transversal lines are printed as the printhead structure is caused to move across the sheet 1. Other examples of suitable digital printers, or print-on-demand printers, are laser printers, toner jet printers and the like. One or both sides of the sheet may be printed with an advertising image. In case both sides of the sheet are printed the advertising images printed thereon may be the same or different.

One example of an inkjet printer suited for use in the present invention is a flat bed inkjet printer from Nur Macroprint Ltd. Such a printer has a capacity to print about 120 m² per hour.

The sheet 1 of corrugated cardboard constitutes an entire placarding surface and the matter printed by the printing unit 2 constitutes a complete advertising image. A standard size of the sheet is 1.6×3.2 m, but may of course be varied within wide ranges.

The corrugated cardboard used in the sheet is preferably a laminated corrugated cardboard having an inner core of corrugated cardboard, i.e. a fluting 4 sandwiched between liners 5. At least one of the outer layers 6 of the laminate is a bleached calendered liner, preferably Kraft liner, suited for printing. The other outer layer can be of an optional suitable material, or is of the same bleached calendered liner material. Between the core of corrugated cardboard 4,5 and the outer layers 6 there is provided a moisture barrier in the form of a hydrophobic or liquid impervious intermediate layer 7. Said moisture barrier preferably is a coating of a thermoplastic polymeric material. The moisture barrier preferably allows the sheet to be recycled without first having to remove said barrier.

One example of a corrugated cardboard laminate useful in the present invention comprises an inner core of corrugated cardboard having a fluting 4 sandwiched between two layers of recycled Euroliner from SCA, each having a basis weight of 180 g/m². The outer layers 6 are of white calandered Kraft liner from Fiskeby, each having a basis weight of 40 g/m². The moisture barrier is of white PE, basis weight 20 g/m². The PE material has been applied between the layers 5 and 6 by heat extrusion, and also acts as boding agent to laminate said layers together.

In a subsequent process step inline with the printing step at least one score or groove 3 is made in the sheet of corrugated cardboard in the feeding direction thereof. In the embodiment shown in the drawings two scores or grooves 3 are made in the sheet. Any suitable means may be used for providing the desired scores or grooves. Thus knives, needles or any other sharp objects may be used. In the drawings there are shown a pair of grooving rolls 7. The scores or grooves are preferably made in the longitudinal direction of the fluting 4 of the corrugated cardboard.

The printed sheet 1 is then folded about the grooves 3 to make an easily transportable unit thereof. In the embodiment shown two grooves 3 are made and the sheet 1 is thus folded in three parts or panels, two outer 1′, 1′″ and one intermediate panel 1″. One of the outer panels 1′ is preferably made with a somewhat greater width than the other panels, so that when the sheet is folded said panel 1′ will project a certain distance outside of the other panels and form a gripping edge 10.

The folded sheet is then transported to a placarding site having a holder 8 for the sheet. The sheet is unfolded and applied in the holder. Any suitable holding means for receiving and holding the sheet 1 in the holder may be used, such as grooves 9 along the edges of the holder, clamping means etc.

The method and system according to the invention provides a rationalised procedure all the way from printing the advertising message onto a placard and putting up the placard at the placarding site. The digital print-on-demand printing technique used further makes it possible to quickly change printing pattern in order to print different patterns in a rapid succession in an inline process.

1-9. (canceled)

10. Method of placarding, which comprises the following steps:
a) taking a sheet of corrugated cardboard, said sheet comprising a laminate having an inner core of corrugated cardboard, at least one outer layer of bleached calendered liner and a moisture barrier in the form of a hydrophobic or liquid impervious intermediate layer located between said outer layer of calendered liner and said inner layer of corrugated carboard;
b) feeding said sheet of corrugated cardboard through a printing unit, and printing matter on at least one surface of said sheet by a digital print-on-demand technique, said sheet constituting an entire placarding surface and the matter printed by the printing unit constituting a complete advertising image;
c) in a subsequent process step in-line with the printing step, making at least one score or groove in the sheet of corrugated cardboard in the feeding direction thereof;
d) folding the sheet about said at least one score or groove to make an easily transportable unit of said sheet;
e) transporting the folded sheet to a placarding site having a holder for the sheet; and
f) unfolding the sheet and applying it in the holder.

11. Method as claimed in claim 10, wherein the printing technique used for printing said sheet of corrugated cardboard is selected from: inkjet printing, laser jet printing and toner jet printing.

12. Method as claimed in claim 10, wherein said at least one score or groove is made in the longitudinal direction of the fluting of the corrugated cardboard.

13. System for placarding, which comprises:
a) a sheet of corrugated cardboard, said sheet comprising a laminate having an inner core of corrugated cardboard, at least one outer layer of bleached calendered liner and a moisture barrier in the form of a hydrophobic or liquid impervious intermediate layer located between said outer layer of calendered liner and said inner layer of corrugated cardboard;
b) means for feeding said sheet of corrugated cardboard through a printing unit adapted to print matter on at least one surface of said sheet by a digital print-on-demand technique, said sheet constituting an entire placarding surface and the matter printed by the printing unit constituting a complete advertising image;
c) means for making at least one score or groove in the sheet of corrugated cardboard in the feeding direction thereof, said means for printing and for making the score or groove being arranged in-line;
d) means for folding the sheet about said at least one score or groove to make an easily transportable unit of said sheet; and
e) a holder placed at a placarding site, said holder being adapted to receive the sheet in an unfolded position to expose the image.

14. System as claimed in claim 13, wherein said calendered liner in a Kraft liner having a basis weight between 30 and 50 g/m2.

15. System as claimed in claim 13, wherein said intermediate layer is a coating or extrusion of a thermoplastic polymeric material.

16. System as claimed in claim 15, wherein said intermediate layer has a basis weight between 10 and 30 g/m2.

17. System as claimed in claim 14, wherein said intermediate layer is a coating or extrusion of a thermoplastic polymeric material.
